(19) United States
(12) Patent Application Publication
(10) Pub. No.: US 2005/0223358 A1
(43) Pub. Date: Oct. 6, 2005

(54) Steering run time non-volatile storage access requests to run time inaccessible storage resources

(76) Inventors: Michael A. Rothman, Puyallup, WA (US); Vincent J. Zimmer, Federal Way, WA (US)

Correspondence Address: TROP PRUNER & HU, PC, 8554 KATY FREEWAY, SUITE 100, HOUSTON, TX, 77024, US

(21) Appl. No.: 10/818,608

(22) Filed: Apr. 6, 2004

(51) Int. Cl. G06F 9/44

(52) U.S. Cl. 717/120; 717/162

(57) ABSTRACT

Non-volatile storage resources associated with third party supplied hardware may be made accessible during operating system run time. Conventionally, these resources are inaccessible to the operating system because no standardized way to access them exists. By collecting configuration data during the pre-boot stage and associating that information with a platform non-volatile storage accessor function that is accessible during run time, the third party supplied storage resources may be accessed during run time.

### BACKGROUND

This invention relates generally to processor-based systems and, particularly, to accessing storage resources associated with third party supplied accessories.

The operation of processor-based systems may be implemented in stages, including an initial stage called the pre-boot stage, in which the system is initialized and the operating system is booted. This initial stage is generally handled by firmware. After the operating system is booted, the operating system takes over control of the system in a run time stage.

Any given platform or processor-based system may include components supplied by the system manufacturer. After acquisition, the user may add additional devices to the system which can be called accessories. These accessories include anything that the user adds to the system that is received from the platform manufacturer. Examples of such accessories include add-in cards, redundant array of independent disks (RAID) cards, small computer system interface (SCSI) host adapters, network cards, baseboard management controllers (BMC), peripherals and, in general, any device containing configuration information that a user can add after the user acquires a processor-based system.

During run time, the operating system may be unable to access non-volatile storage resources associated with these various accessories. The operating system has no tools with which to access these resources. Thus, these resources are generally inaccessible during run time.

Thus, there is a need for a way to access accessories that are not accessible by the operating system during run time.

### BRIEF DESCRIPTION OF THE DRAWINGS

FIG. 1 is a schematic depiction of a platform in accordance with one embodiment of the present invention;

FIG. 2 is a schematic depiction of the operation of one embodiment of the present invention; and

FIG. 3 is a flow chart for software in accordance with one embodiment of the present invention.

### DETAILED DESCRIPTION

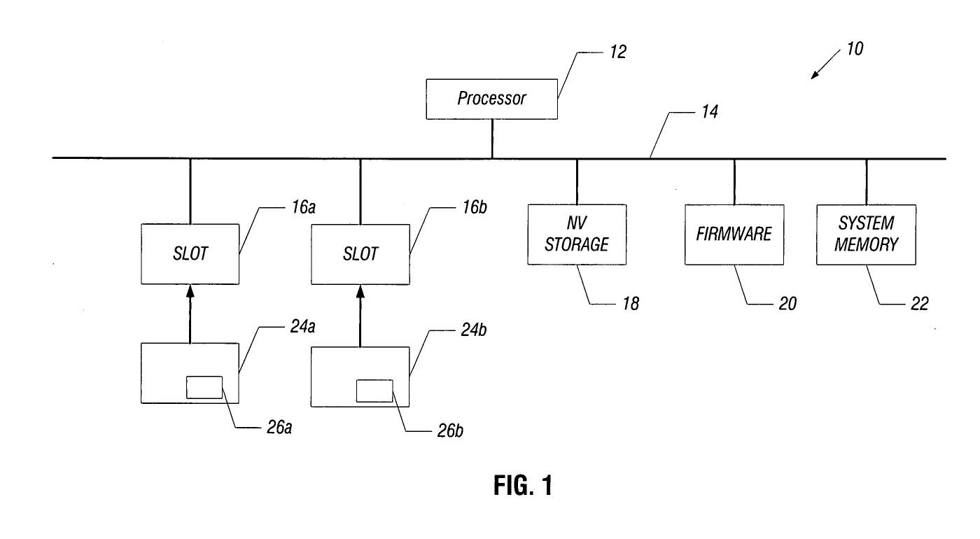

Referring to FIG. 1, a manufacturer supplied processor-based system or motherboard 10 may include a processor 12, coupled by a bus 14, to various components. The bus 14 may include a number of empty slots 16 as supplied by the manufacturer. Once the user acquires the system or motherboard 10, the user may insert cards 24 into those slots 16. These cards 24 may be called add-in cards and may include non-volatile storage 26.

While an illustration is provided in which the user adds cards 24 to slots 26, the present invention may involve any type of accessory which may be coupled to the system or motherboard 10 by the user. These accessories generally are provided by third party suppliers. The third party supplier is a third party in the sense that it is different from the manufacturer of the system or motherboard 10. The accessories may be coupled by cables, connectors, or wireless connections.

The system or motherboard 10 may have its own non-volatile storage 18. This non-volatile storage 18 is accessible during run time. To this end, an application program interface or accessor function is accessible during run time.

Also coupled to the bus 14, may be a basic input/output system (BIOS) or firmware 20. The firmware 20 may include the extensible firmware interface (EFI) in one embodiment of the present invention. Finally, a system memory 22 may be provided on the bus 14.

The system or motherboard 10, shown in FIG. 1, is for illustration purposes only. It is a simple example, and is not meant to in any way limit the scope of the present invention. The present invention may encompass a wide number of system architectures other than that shown in FIG. 1.

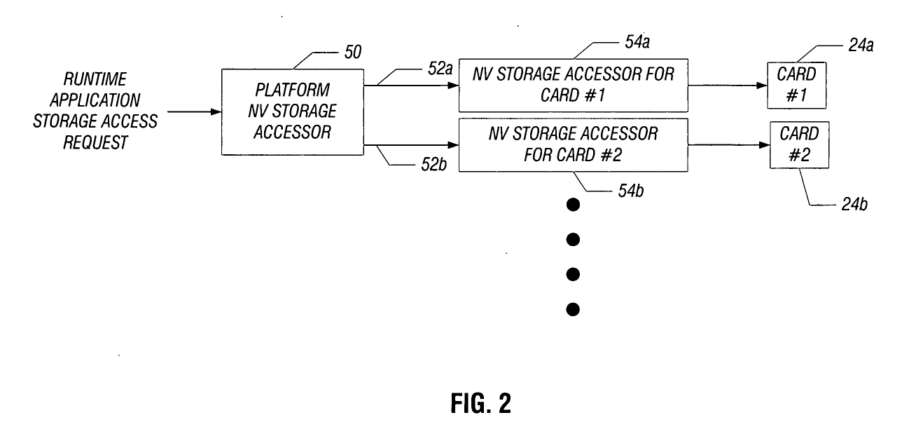

Referring to FIG. 2, during run time, applications may seek to access non-volatile (NV) storage either on the motherboard 10, such as a non-volatile storage 18, or they may attempt to access non-volatile storage 26 associated with an add-in card 24, plugged into a slot 16. To this end, the accessories, such as cards 24a and 24b, may be assigned globally unique identifiers or GUIDs which uniquely identify each accessory, such as card 26. This assignment may occur during the pre-boot stage.

During the pre-boot, the accessories, such as the cards 26, advertise their services so that configuration data stored on those accessories is accessible. Of course, the availability of the configuration data during the pre-boot stage is no help during run time because applications operating during run time cannot access that pre-boot stage accessible configuration data.

By capturing that configuration data during the pre-boot stage and associating it with a GUID, non-volatile storage 26a and 26b on the cards 24a and 24b, respectively, can be made accessible during run time. This accessibility may be achieved by associating both the GUID and the configuration data with the platform non-volatile storage accessor 50. The platform non-volatile storage accessor 50 is a recognized abstraction that may be provided, in one embodiment, by the extensible firmware interface. Run time applications have knowledge of and are able to access the extensible firmware interface provided, non-volatile storage accessor 50.

When accessing a firmware interface provided, non-volatile storage accessor storage resource, run time applications may specify a globally unique identifier or GUID for that resource. The platform non-volatile storage accessor 50 then de-multiplexes the access request, based on the specified GUID, and determines the configuration data, for the specified resource, which was collected during the pre-boot stage. As a result, the access request can be steered, as indicated at 52a and 52b, to the appropriate card 24's non-voltage storage 26, as indicated in blocks 54a and 54b. In effect then, the run time access request may be steered by the generally accessible platform non-volatile storage accessor 50 to the appropriate accessory.

In this way, the non-volatile storage 26 on accessories can be made accessible even though the operating system has no ability, in and of itself, to access such resources. As a result, storage resources on accessories can be made accessible without any modification to run time applications or the operating system in some embodiments. Instead, this accessibility may be handled by the firmware 20, such as the basic input/output system or the extensible firmware interface, as two examples.

In this regard, a set up application in the pre-boot stage can search for those application program interfaces associated with add-in cards or other accessories so that configuration data can be stored in association with the non-volatile storage 18 on the motherboard or system 10 in the pre-boot environment. In effect then, a configuration table may be established in the pre-boot environment that may then be accessed, for example through extensible firmware interface (EFI) services, during the run time environment. For example, the system table may provide access to EFI run time services that provide an abstraction for the platform non-volatile storage 18 during run time.

By adding logic to the firmware 20, the different storage resources associated with different accessories may be differentiated. This logic may recognize GUIDs and associate them with different storage resources associated with various accessories. In one embodiment, the GUID is a unique 128 bit value. The GUID may also include human readable forms as well.

Since the GUID is already known to the operating system, the operating system is fully capable of enumerating the GUID in any access requests to the non-volatile storage accessor 50.

To establish the relationships between the various accessories and their GUIDs, the platform non-volatile storage accessor 50 locates each accessory storage during the configuration steps of the pre-boot stage using standard interfaces of each accessory. Each accessory's interface may advertise its GUID during the pre-boot stage.

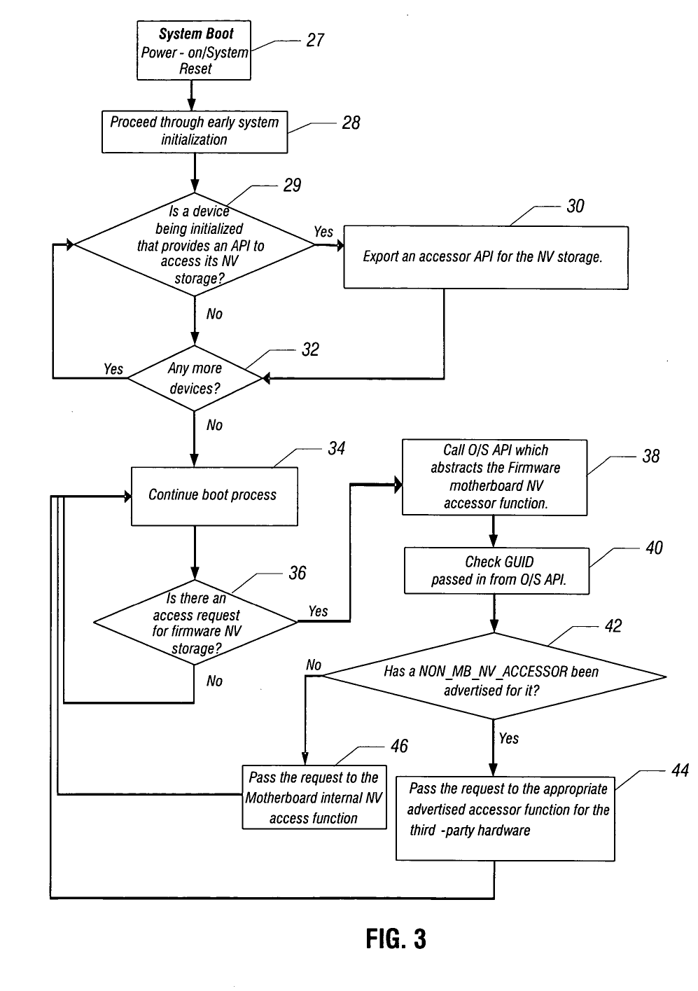

Referring to FIG. 3, software for implementing one embodiment of the present invention may be provided at least in part within the firmware 20 in one embodiment. On power on or system reset, the platform, including the system or motherboard 10, boots through the operation of firmware 20 as indicated in block 27. The boot process proceeds through early system initialization as indicated in block 28. At diamond 29, a determination is made as to whether an accessory, being initialized, provides an application program interface (API) to access its own non-volatile storage. The accessory being initialized may be an add-in card 24, provided in a slot 16, as one example. If the accessory does not advertise such an API, a check at diamond 32 determines whether any more accessories need to be initialized. If so, the flow iterates until all of the initializable accessories have been handled.

If an accessory being initialized does provide an API to access its non-volatile storage, an accessor API for that non-volatile storage is exported to the non-volatile storage 18 accessor 50. The exported API is one that is advertised by the accessory, such as a card 24, and includes a specific GUID to indicate to the firmware 20 which non-volatile storage resource is the target of the request.

As indicated in block 34, the boot process continues running the firmware 20 up to and including running the operating system. After block 34, the system enters the run time environment. At block 36, the operating system determines whether there is an access request for a firmware non-volatile storage 18. If so, the operating system calls an application program interface that abstracts the firmware non-volatile accessor 50 for the motherboard 10 non-volatile storage 18 as indicated in block 38.

At block 40, the GUID associated with the access request is passed in from the operating system API to the firmware 20.

At diamond 42, the firmware 20 again handles operations. At diamond 42, a check determines whether a non-motherboard, non-volatile storage accessor has been advertised for the GUID that was included in an operating system storage access request. If not, the request can be passed to an internal non-volatile storage access function as indicated in block 46. If so, in block 44, the request is steered to the appropriate advertised accessor function for the hardware accessory.

In some embodiments of the present invention, multiple storage targets may be made accessible without encumbering the motherboard firmware 20. Also, in some embodiments, operating system involvement is unnecessary to enable such steerability, because no drivers and no user-mode applications that are specific to the ultimate storage devices are needed. In addition, there is no need to provide a standardized accessor function for every third party accessory, in some embodiments.

In some embodiments of the present invention, the association between the accessory accessor functions and the GUIDs may be implemented during run time. For example, a distinguished operating system driver may be provided that creates a boot service-like environment. Namely, the driver may wrap up boot services in an operating system-specific driver. Then, when the boot service drivers are run again during operating system run time, the operating system may proxy any privileged operations through itself into the platform.

While an embodiment is illustrated in which the third party supplied devices are add-in cards 24, the present invention may also be applicable to other storage systems such as RAID cards, network cards with programmable aspects to contain media access control (MAC) addresses, and a BMC. In general, any third party supplied hardware that has a non-volatile storage with configuration data may benefit by an embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
steering an operating system non-volatile storage access request to storage that is inaccessible to the operating system.

2. The method of claim 1 including using a platform non-volatile storage accessor to facilitate access to non-platform non-volatile storage.

3. The method of claim 1 including steering an operating system non-volatile storage access request to storage associated with an accessory.

4. The method of claim 3 including associating a non-volatile storage resource with its configuration data during the boot stage.

5. The method of claim 1 wherein steering an operating system non-volatile storage access includes using a globally unique identifier to determine the storage resource targeted by the request.

6. The method of claim 1 including using an extensible firmware interface run time service to enable storage resource access request to be directed to a platform non-volatile storage accessor.

7. The method of claim 1 including accessing an application program interface for one non-volatile storage resource provided as an accessory to a platform.

8. The method of claim 7 including accessing an application program interface during the boot stage for at least two accessories.

9. The method of claim 8 including establishing a table which associates accessory storage resources with globally unique identifiers.

10. The method of claim 9 including associating globally unique identifiers with each of at least two accessories during the boot stage.

11. An article comprising a medium storing instructions that, if executed, enable a platform to:
steer an operating system non-volatile storage access request to storage that is inaccessible to the operating system.

12. The article of claim 11 further storing instructions that, if executed, enable the platform to use a platform non-volatile storage accessor to facilitate access to non-platform non-volatile storage.

13. The article of claim 11 further storing instructions that, if executed, enable the platform to steer an operating system non-volatile storage access request to storage associated with an accessory.

14. The article of claim 13 further storing instructions that, if executed, enable the platform to associate a non-volatile storage resource with its configuration data during the boot stage.

15. The article of claim 11 further storing instructions that, if executed, enable the platform to use a globally unique identifier to determine the storage resource targeted by the request.

16. The article of claim 11 further storing instructions that, if executed, enable the platform to use an extensible firmware interface run time service to enable a storage resource access request to be directed to a platform non-volatile storage accessor.

17. The article of claim 11 further storing instructions that, if executed, enable the platform to access an application program interface for a non-volatile storage resource provided as an accessory to the platform.

18. The article of claim 17 further storing instructions that, if executed, enable the platform to access an application program interface during the boot stage for at least two accessories.

19. The article of claim 18 further storing instructions that, if executed, enable the platform to establish a table that associates accessory storage resources with globally unique identifiers.

20. The article of claim 19 further storing instructions that, if executed, enable the platform to associate globally unique identifiers with each of at least two accessories during the boot stage.

21. A platform comprising:
a processor; and
a storage, storing instructions that, if executed, enable the platform to steer an operating system non-volatile storage access request to storage that is inaccessible to the operating system.

22. The platform of claim 21 wherein said storage stores instructions that, if executed, enable the platform to use a platform non-volatile storage accessor to facilitate access to non-platform non-volatile storage.

23. The platform of claim 21 wherein said storage stores instructions that, if executed, enable the platform to steer an operating system non-volatile storage access request to storage associated with an accessory.

24. The platform of claim 23 wherein said storage stores instructions that, if executed, enable the platform to associate a non-volatile storage resource with its configuration data during the boot stage.

25. The platform of claim 21 wherein said storage further stores instructions that, if executed, enable the platform to use a globally unique identifier to determine the storage resource targeted by the request.

26. The platform of claim 21 wherein said storage further stores instructions that, if executed, enable the platform to use an extensible firmware interface run time service to enable a storage resource access request to be directed to a platform non-volatile storage accessor.

27. The platform of claim 21 wherein said storage further stores instructions that, if executed, enable the platform to access an application program interface for a non-volatile storage resource provided as an accessory to the platform.

28. The platform of claim 27 wherein said storage further stores instructions that, if executed, enable the platform to access an application program interface during the boot stage for at least two accessories.

29. The platform of claim 28 wherein said storage further stores instructions that, if executed, enable the platform to establish a table that associates accessory storage resources with globally unique identifiers.

30. The platform of claim 29 wherein said storage further stores instructions that, if executed, enable the platform to associate globally unique identifiers with each of at least two accessories during the boot stage.

31. The platform of claim 20 including a non-volatile storage.

32. The platform of claim 31 wherein said platform is a motherboard.

33. The platform of claim 32 wherein said motherboard includes slots to receive add-in cards.
